(19) United States
(12) Patent Application Publication
(10) Pub. No.: US 2004/0199782 A1
(43) Pub. Date: Oct. 7, 2004

(54) Privacy enhanced storage

(75) Inventor: Gordon Kent Arnold, Cary, NC (US)

Correspondence Address: HARRINGTON & SMITH, LLP, 4 RESEARCH DRIVE, SHELTON, CT, 06484-6212, US

(73) Assignee: International Business Machines Corporation

(21) Appl. No.: 10/404,977

(22) Filed: Apr. 1, 2003

(51) Int. Cl. H04L 9/00

(52) U.S. Cl. 713/200

(57) ABSTRACT

A method and system for providing privacy enhanced handling of data, the method including indexing an identity of an entity storing a data file to a privacy policy, associating the data file with the privacy policy, storing the data file and the associated privacy policy, evaluating the privacy policy associated with a data file and indexed to an entity, determining whether the privacy policy will permit access to the data file, and granting access to the data file in response to the determination.

### BACKGROUND OF THE INVENTION

1. Field of the Invention

The present invention relates data storage. More particularly, the present invention relates to a method and system for providing privacy enhanced data storage including a privacy policy.

2. Description of the Related Art

The advent of the Internet, declining digital data storage costs, and evolving business practices have contributed to an exponential growth in the number and frequency of electronic transactions or exchanges of digital data over computer networks. Privacy of data, and in particular data including personal identifiable information (PII) has become and continues to be a major concern for individuals, businesses, governmental agencies, and privacy advocates. Along with the growth in digital data exchanges has come an increased awareness and concern for the privacy of PII requested and/or required to complete the electronic data transaction and questioning of whether the PII data is or should be divulged to the requesting party.

Various businesses, regulatory organizations, think tanks, and consortiums have addressed the privacy of data in electronic transactions. A number of privacy policies have been proposed for adaptation to enhance the privacy of data during the electronic collection, storage, and dissemination of the data. The privacy policies tend to address privacy concerns related to the data that is general and/or specific in nature to a particular industry, business, or type of transaction. For example, privacy policy standards are being developed and/or have been published for data collection, storage, and dissemination related to financial transactions, the health care industry (e.g., medical records), and Wide World Web (i.e., the Web) data collection.

Known privacy systems may provide measures for observing a privacy policy that outlines the access rights associated with data stored by the system. However, these systems do not maintain the privacy policy with the data stored by the system. Therefore, when, for example, retrieving the stored data these known systems fail to provide a manner for determining whether the privacy policy has been observed. Additionally, a data privacy policy may vary depending on the entity storing and/or attempting to access the data.

Therefore, there exists a need to provide a privacy enhanced storage method and system for providing secure data storage, including maintaining the privacy policy with the data to ensure compliance with the privacy policy.

### SUMMARY OF THE INVENTION

The method and system of the present invention provides a privacy enhanced handling of data, the method including indexing an identity of an entity storing a data file to a privacy policy, associating the data file with the privacy policy, and storing the data file and the associated privacy policy. A method is disclosed herein for evaluating a privacy policy associated with a data file and indexed to an entity, determining whether the privacy policy will permit access to the data file, and granting access to the data file in response to the determination.

The present invention includes a system including a privacy policy, a processor for indexing an identity of an entity storing a data file to the privacy policy, and for associating the data file with the privacy policy, and a file system for storing the data file and associated privacy policy.

The advantages and benefits of the present invention will be more fully understood by reference to following detailed description and appended sheets of drawings.

### BRIEF DESCRIPTION OF THE DRAWINGS

FIG. 1 is an overall schematic of an exemplary network environment suitable for the implementation of the privacy enhanced storage system and method of the present invention;

FIG. 2 is a flow diagram of a data write process in accordance with the privacy enhanced storage system and method of the present invention; and

FIG. 3 is a flow diagram of a data read process in accordance with the privacy enhanced storage system and method of the present invention

### DETAILED DESCRIPTION OF THE INVENTION

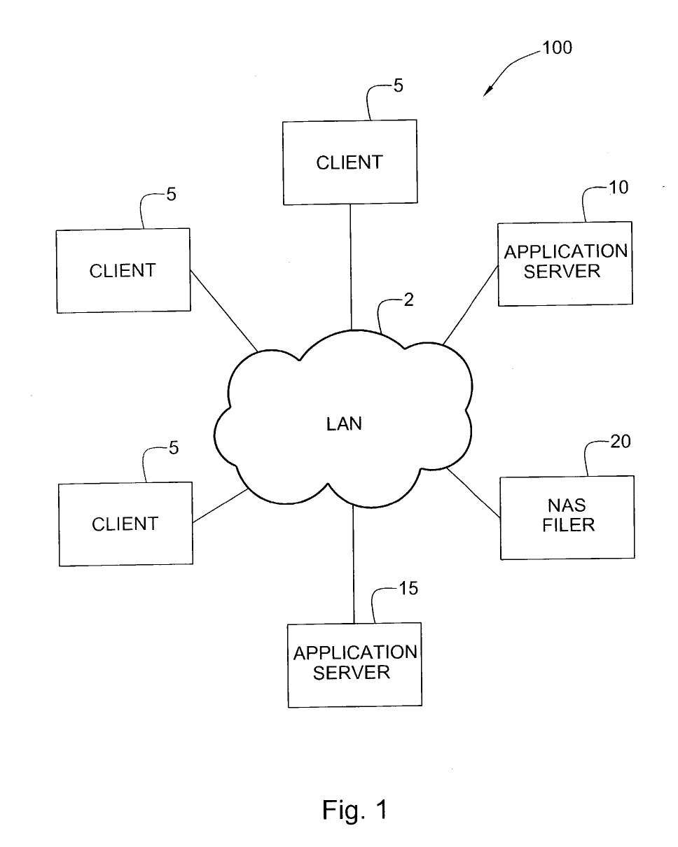

Referring to the drawings and in particular FIG. 1, there is provided an exemplary network environment suitable for implementation of the present invention of a method and system for privacy enhanced storage. While the present invention will be described primarily in the context of the environment depicted in FIG. 1, this is done primarily for purposes of clarity and conciseness in describing the present invention and is not a limitation of the present invention.

In many businesses and organizations that exchange digital data, storage networking is utilized to gain the benefits of, for example, centralized storage, file sharing, and scalability. Network environment 100 illustrates a number of devices connected to a network 2. Network 2 is a LAN but it may be a WAN. Attached to network 2 are clients 5, application servers 15, and a NAS filer or appliance 20. Network 2 is preferably a TCP/IP based Ethernet network, but can be any network that supports the IP-based protocol used by NAS appliance 20. NAS filer 20 preferably has an integrated processor and disk storage. NAS filer 20 is preconfigured and optimized to support specific file-serving (i.e., data sharing) tasks among clients 5.

NAS filer 20 is shown connected to network 2. Integrated storage device NAS filer 20 handles the task of file serving. NAS filer 20 preferably communicates over network 2 using a device independent NFS (Network File System) or CIFS (Common Internet File System) file-level I/O protocol for accessing and sharing data. NAS appliance 20 includes an operating system or operating system kernel and tracks where files are stored on disk and issues a block I/O request to the disk(s) to fulfill the file I/O read and write requests it receives.

NAS filer 20 can provide the capability of operating in a heterogeneous operating environment such as, for example, a health care management system wherein parts of the system operate under UNIX® and other segments operate under Microsoft Windows®. The capability to support both NFS (UNIX®) or CIFS (Microsoft Windows®) I/O protocols enables cross-platform data sharing that may be needed to share, for example, patient data files including PII data between a health care provider (e.g., a doctor) and a health insurer.

While there may exist a desire to exchange the patient data between the health care provider and the health insurer, there also exists a need, possibly a mandatory need, to ensure that the data is exchanged in a manner that maintains the privacy of the personally identifiable information (PII) patient data. That is, there is a need to limit the non-consensual use and release of PII patient data to ensure that only the right (i.e., authorized) entity has access to the data.

Regarding the need to ensure that patient data is exchanged in a manner that maintains the privacy of the PII patient data, the Health Insurance Portability & Accountability Act of 1996 (HIPAA) mandates the protection of the confidentiality and security of health data through the setting and enforcement of standards that limit the right to access personally identifiable health information. HIPAA specifically calls for security standards protecting the confidentiality and integrity of PII health related information.

It should be appreciated that privacy standards, whether established by a government, business organization, or other entity, mandated or voluntarily adopted by a business or a particular industry (e.g., financial securities), may encompass privacy policies other than HIPAA. HIPAA is but one example, provided herein as an illustrative example of such a privacy regulation.

In an aspect of the present invention, a privacy policy including the terms and conditions of access rights to data is integrated into a storage system and method, thereby providing enhanced privacy storage. The privacy policy may include, but is not limited to, HIPAA. The storage and validation of the data is combined as an integral part of file system operations.

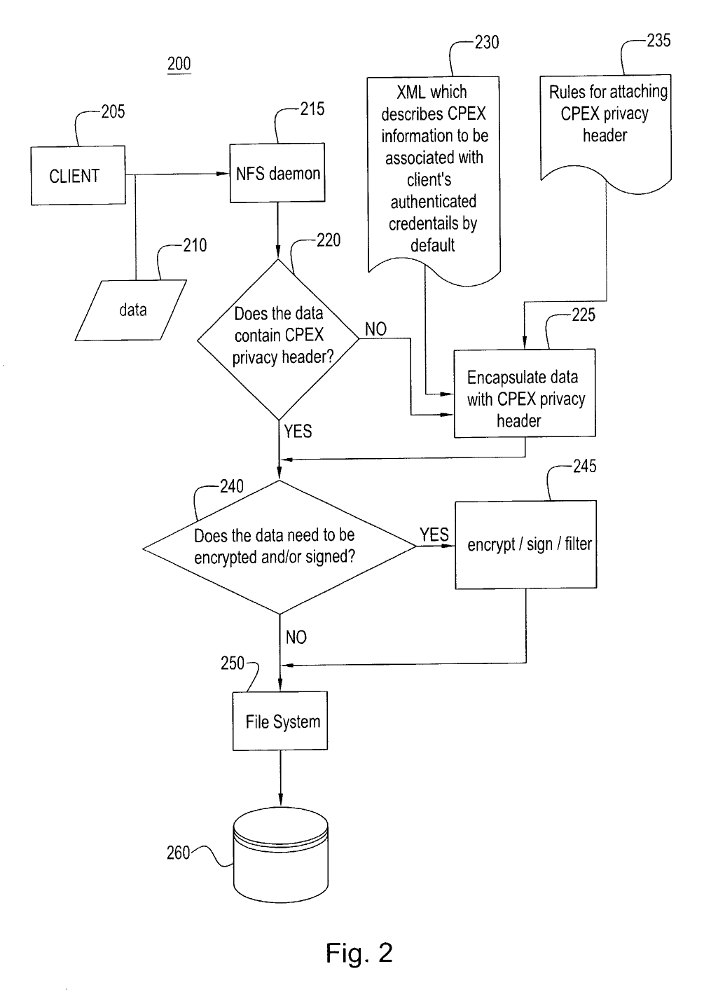

FIG. 2 depicts an exemplary execution of a data write process 200 in accordance with the present invention. In particular, FIG. 2 illustrates aspects of data write process 200. Client 205 issues a write command to write data 210. Client 205 may include, for example, a medical imaging device that captures and stores an x-ray image of a patient and associates the x-ray image with patient PII data such as the patient's name, birth date, gender, medical condition, etc. Data 210 includes, inter alia, the x-ray imaged and the patient PII data. NAS filer 20 receives the write command via network 2 and a software implemented NFS daemon 215 running on NAS filer 20 invokes the data write process 200 further depicted in FIG. 2.

In an aspect of the present invention, the privacy requirements regarding data 210 data are preferably described in a standardized manner so as to be compatible across heterogeneous operating systems, network configurations, and applications. An example of an open standard for sharing PII data across disparate applications and systems is the Customer Profile Exchange (CPEX) standard. CPEX is based on Extensible Markup Language (XML) which is itself an open internet standard. CPEX provides a technology standard for facilitating the exchange of PII by standardizing the syntax and semantics of a privacy policy (e.g., HIPAA).

Referring to step 220 in FIG. 2, NFS daemon 215 determines whether data 210 contains a CPEX compliant privacy header. Inclusion of the CPEX privacy header 210 with data 210 ensures that the privacy policy governing data 210 is maintained with data 210 as data 210 is stored. The CPEX privacy header designates, formats, and maintains data 210 as private. If it is determined at step 220 that data 210 does not contain a CPEX compliant privacy header then data 210 is encapsulated with a CPEX header at step 225. Encapsulating or wrapping data 210 with the CPEX header includes storing meta-data capturing the privacy policy 230, and other rules 235 for attaching the CPEX header with data 210.

Meta-data describing privacy policy 230 is preferably implemented using XML-based CPEX but may be implemented using any language, syntax, and semantics for describing personal data that will be associated with an authenticated entity. In the present example, the authenticated identity of a patient, doctor, or other health care system entity identified by data 210 as requesting storage of data 210 is indexed to data 210 in compliance with privacy policy 230. The PII (i.e., the identity) of the data writing entity is used to populate CPEX formatted privacy header 230.

Rules 235 provide the rule(s) or conditions for attaching the CPEX privacy header to data 210. Rules 235 capture relationships that are to be observed in ensuring that access, and the scope of the access, to data 210 is limited to only authorized entities. For example, one of the rules 235 may stipulate that a doctor wishing to access data 210 must be verified as being the attending physician of the patient to which data 210 relates. Another exemplary rule may stipulate that only a portion of the data is made accessible to the requesting entity if they satisfy the conditions of the rule, while still other example rules stipulate that access to data 210 is either all or none based on the satisfaction of the relevant rule. It should be appreciated that other rules expressing relationships between various entities and data 210 are possible.

In an aspect of the present invention, rules 235 are utilized to limit access to data 210 only to an authorized entity identified as having access rights to the data. Accordingly, rules 235 preferably express the privacy disclosure requisite(s) for data based on real-world relationships such as, for example, doctor/patient, doctor/hospital, patient/health insurer, etc. Rules 235 may be incorporated into the system and method of the present invention by a network, LAN, or system administrator.

Data 210 is encapsulated (i.e., “wrapped around”) in the CPEX compliant privacy policy header that captures privacy policy 230 and rules 235 at step 225. The privacy policy 230 and associated rules 235 remain attached to data 210 during the data write process 200.

In response to data 210 being encapsulated with the CPEX compliant privacy header at step 225 or otherwise determined as containing the CPEX privacy header at step 220, data write process 200 proceeds to step 240. At step 240 a determination is made whether data 210 is to be encrypted, digitally signed, and/or filtered. Encrypting, is filtering, and/or requiring a digital signature at step 240 provides an additional level of privacy protection to data 210. Whether data 210 is encrypted, digitally signed, and/or filtered is preferably based on the CPEX described privacy policy 230 and rules 235.

As used herein, encrypting includes translating data into a secret code. A digital signature is used herein to refer to, inter alia, a digital code that can be attached to data to uniquely identify an entity. For example, if it is determined at step 240 that data 210 is to include a digital signature, then a digital signature uniquely identifying the attending doctor creating data 210 (i.e., the x-ray) is electronically attached to data 210. Data 210 including the digital signature can thus be identified as being generated by the attending doctor.

As mentioned above, data 210 may be filtered at step 240. Filtering refers the process of removing or stripping PII from data 210. That is, PII associated with data 210 is removed from data 210. Data 210 filtered (i.e., stripped) of PII can be used, for example, in statistical analysis, information gathering, and other processes without the risk of compromising the privacy of data 210. For example, data such as a patient's x-ray image can be filtered to mask the PII (e.g., patient's name, social security number, etc.). In order to track and correlate the filtered x-ray to the patient in the present example, a random number may be substituted for the filtered PII and keyed back to the file system for tracking with the patient. Filtering data 210 at step 245 can be used in combination with encryption and/or a digital signature.

The determination of whether data 210 is to be encrypted, filtered, and/or digitally signed can be based on, for example, a privacy indicator included in the CPEX privacy header or rules 235. In response to the determination of whether to encrypt, digitally sign, and/or filter data 210 at step 240 and the encrypting, digitally signing, and/or filtering (if any) of data 210 at step 245, data write process 200 proceeds to pass data 210 to a file system 250. File system 250 can be any file system or file management system application for organizing and keeping track of data files.

File system 250 stores data 210 on disk 260. Disk 260 may be implemented in a variety of storage configurations including, but not limited to, a RAID (Redundant Array of Independent Disks) disk drive and networked storage.

As shown in FIG. 2, the enforcement and compliance with privacy policy 230 for the storage of data 210 can be implemented in a manner that is transparent to an application that may use the data. For example, it is noted that the wrapping (step 225) and encrypting/signing/filtering (step 245) of data 210 takes place after client 205 issues the data write command and before data 210 is passed to file system 250. The privacy enhanced aspects of the present invention are added to data 210 before the data is passed to file system 250. Thus, it is not necessary to modify an application implementing file system 250 in order to accommodate the privacy enhanced storage method and system of the present invention. It is also seen that other applications, such as those running on client 205, do not require modification in order to interface with the enhanced privacy aspects of the present invention.

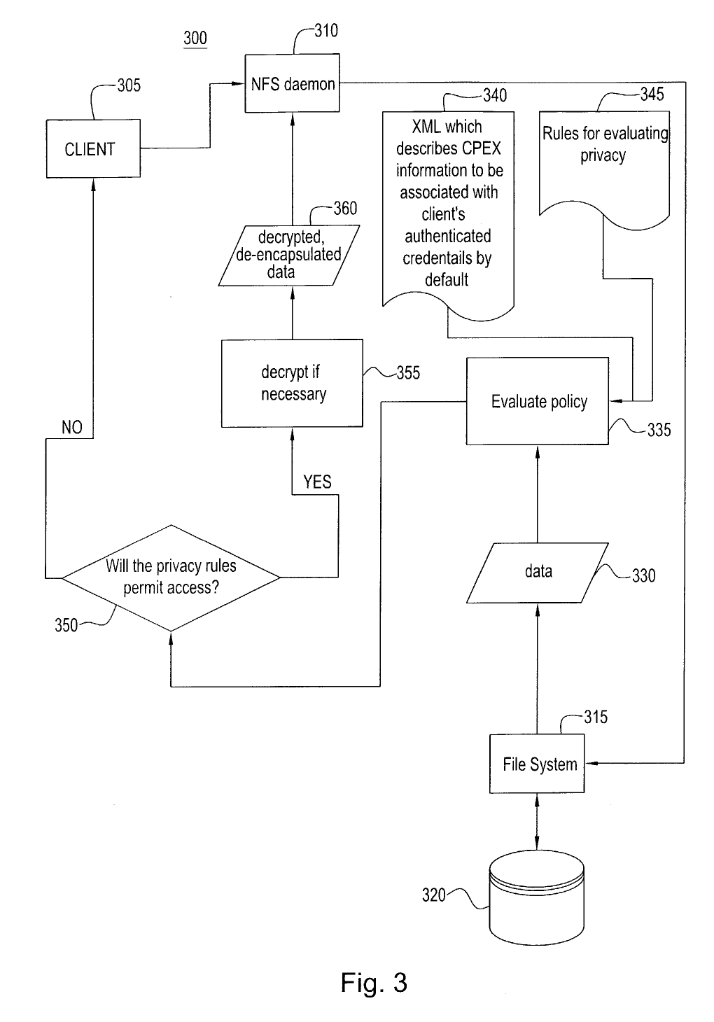

FIG. 3 depicts a data read process 300 illustrating an exemplary data read in accordance with the privacy enhanced data storage system and method of the present invention. Initially, client 305 issues a data read command to NAS filer 20 over network 2 in the appropriate I/O protocol (e.g., NFS, CFIS, etc.). NAS filer 20 receives the data read command and a NFS daemon 310 running on NAS filer 20 is invoked to perform a data read process in accordance with the issued data read command. Accordingly, NFS daemon 310 communicates with file system 315. File system 315 organizes and keeps track of the files stored on disk 320. File system 315 accesses and retrieves the requested data specified by the data read command from disk 320.

Upon retrieval of the requested data 330 from disk 320 by file system 315, data 330 is evaluated for compliance with a privacy policy 340 and rules 345 at step 335 by NAS filer 20. In the example of FIG. 3, the identity of the patient, doctor, or other health care system entity identified by PII data provided in a log-on during the privacy enhanced storage of the data is indexed to data 330. The identity is preferably stored in the form of PII data populating CPEX privacy header 340 encapsulating data 330. CPEX privacy header 340 is preferably implemented in the manner discussed above regarding data write process 200.

CPEX privacy header 340 is parsed to obtain the identity of the entity that stored the privacy enhanced data 330, the privacy policy, and rules governing access rights to data 330. According to the privacy policy in place at the time data 330 was created, the access rights established by the storing entity, and rules 345, the privacy of data 330 is evaluated at 335 to determine whether access to data 330 should be granted to the entity requesting data 330 via the issued data read. That is, data 330 is evaluated for satisfying privacy policy related data 330 using the identity of the data creating entity as an index. The CPEX information encapsulating data 330 is associated with the identity of the entity that stored data 330 (e.g., a doctor, health insurer, patient, etc.).

Rules 345 are evaluated so that access to data 330 is not granted unless rules 345 are satisfied. Rules 345 are similar to the rules discussed above regarding data write process 200. In particular, rules 345 express the relationships that are observed in order to grant access to data 330. For example, if the data read command for data 330 is generated by a doctor other than the patient's attending specialist, then one of rules 345 can specify that access to data 345 be denied or limited in scope.

By evaluating both the privacy policy header 340 and rules 345, access to data 330 is limited only to the entities satisfying the privacy policy associated with data 330 and rules 345. At step 350, the determination of whether the privacy policy and rules permit access to data 330 is executed. If the privacy policy and rules 345 dictate that data 330 cannot be accessed by the requesting entity, then client 305 is notified of the denied access. Denied access may be communicated to client 305 by use of a null object transmitted to client 305.

In the event that the data read command satisfies rules 345 and the privacy policy at step 350, then data 330 is de-encapsulated (i.e., “unwrapped”) at step 355. That is, the privacy header is removed from data 330. Optionally, data 330 is decrypted at step 355 if data 330 was encrypted during the storage process thereof. If data 330 was not encrypted, then the decrypting aspect of step 355 may be bypassed.

The de-encapsulated “raw” data is passed to NFS daemon 310 for further processing and/or routing as NAS 20 completes its file server tasks. For example, NAS 20 distributes the requested data 330 to client 305.

As illustrated by the foregoing examples, the privacy of data 330 is maintained in an encapsulated and encrypted form until it is determined that the data read request meets the privacy requirements expressed in the privacy policy and rules. The storage of the privacy policy with the data ensures that the pertinent privacy policy is observed in the storage and retrieval of the data.

Data stored and read in accordance with the present invention is returned unaltered by NAS 20, neither encapsulated nor encrypted but in the form the data was initially submitted for storage. Accordingly, the enhanced privacy method and system of the present invention is application independent. Compliance with the privacy policy is attained without necessarily altering an application that may use the data. Therefore, the privacy of archived data can be maintained, notwithstanding possible application modifications over time.

It should also be appreciated by those skilled in the art that the particular network environment, I/O protocol, operating system, application, privacy policy, rules, and other aspects of the invention herein are but examples of the present invention. Thus, they do not limit the scope or variety of applications that the present invention may be suitably implemented. As made clear by the foregoing discussion, the present method and system may be preferably implemented in a file system environment, including a networked environment, without the necessity of altering applications or operating systems. The present method and system combines the storage and validation of CPEX data as an integral aspect of the file system.

Therefore, it should be understood that the foregoing description is only illustrative of a present implementation of the teachings herein. Various alternatives and modifications may be devised by those skilled in the art without departing from the invention. For example, the privacy enhanced storage system and method of the present system may be implemented by a computer readable storage medium (e.g., a removable storage medium, a memory card or a hard disk) having program instructions embodied therein for executing the methods of the present invention. The computer readable storage medium can be read and the program instructions executed by a processor such as NAS 20. Accordingly, providing a privacy enhanced storage system and method can be implemented by a storage medium having computer readable program instructions embodied therein for providing privacy enhanced handling of data, the storage medium including program instructions for evaluating a privacy policy associated with a data file and indexed to an entity, program instructions for determining whether the privacy policy will permit access to the data file, and program instructions for allowing access to the data file in response to the determination that the privacy policy will permit access to the data file.

It should also be appreciated by those skilled in the art that while the present invention has been described in the context of, for example, a NAS file system that the present invention may be adapted to, implemented in, and/or extended to a SAN (Storage Area Network) file system.

It will be apparent, however, that various variations and modifications may be made to the invention, with the attainment of some or all of the advantages of the invention as indicated in the claims appended hereto. Accordingly, the present invention is intended to embrace all such alternatives, modifications, and variances that fall within the scope of the appended claims.

What is claimed is:

1. A method for providing privacy enhanced handling of data, said method comprising:
indexing an identity of an entity storing a data file to a privacy policy;
associating said data file with said privacy policy; and
storing said data file and said associated privacy policy.

2. The method of claim 1, further comprising associating a rule with said data file.

3. The method of claim 2, wherein said rule relates to a relationship between said data file and said entity.

4. The method of claim 1, wherein associating said data file with said privacy policy comprises populating a header of said data file with a description of said privacy policy.

5. The method of claim 1, further comprising encrypting said data file.

6. The method of claim 1, wherein said entity is selected from a group consisting of: a person, an organization, and a network address.

7. A method for providing privacy enhanced handling of data, said method comprising:
evaluating a privacy policy associated with a data file and indexed to an entity;
determining whether said privacy policy will permit access to said data file; and
granting access to said data file in response to said determination.

8. The method of claim 7, further comprising decrypting said data file.

9. The method of claim 7, further comprising removing an indicator of indicative of said entity indexed to said data.

10. The method of claim 7, further comprising evaluating a rule associated with said data file.

11. The method of claim 7, wherein said rule is related to a relationship between said data file and an entity requesting said data file.

12. The method of claim 7, further comprising retrieving said data file from a file system.

13. The method of claim 7, wherein said entity is selected from a group consisting of: a person, an organization, and a network address.

14. A data system comprising:
means for indexing an identity of an entity storing a data file to a privacy policy;
means for associating said data file with said privacy policy; and
means for storing said data file and said associated privacy policy.

15. A data system comprising:
means for evaluating a privacy policy associated with a data file and indexed to an entity;
means for determining whether said privacy policy will permit access to said data file; and
means for granting access to said data file in response to said determination.

16. A data system comprising:
a privacy policy;
a processor for indexing an identity of an entity storing a data file to said privacy policy, and associating said data file with said privacy policy; and
a file system for storing said data file and said associated privacy policy.

17. The system of claim 16, said system further comprising a rule for associating with said data.

18. The system of claim 17, wherein said rule relates to a relationship between said data file and said entity.

19. The system of claim 16, wherein said processor indexes said identity to said data file by populating a header of said data file with an indicator of said entity.

20. The system of claim 16, wherein said processor associates said privacy policy with said data file by populating a header of said data file with a description of said privacy policy.

21. The system of claim 16, wherein said processor determines whether said privacy policy will permit access to said data file in response to an evaluation of said privacy policy.

22. The system of claim 16, wherein said processor encrypts said data file.

23. The system of claim 16, wherein said processor decrypts said data file.

24. The system of claim 16, wherein said entity is selected from a group consisting of: a person, an organization, and a network address.

25. A storage medium having computer readable program instructions embodied therein for providing privacy enhanced handling of data, said storage medium comprising:
program instructions for indexing an identity of an entity storing a data file to a privacy policy;
program instructions for associating said data file with said privacy policy; and
program instructions for storing said data file and said associated privacy policy.

26. A storage medium having computer readable program instructions embodied therein for providing privacy enhanced handling of data, said storage medium comprising:
program instructions for evaluating a privacy policy associated with a data file and indexed to an entity;
program instructions for determining whether said privacy policy will permit access to said data file; and
program instructions for granting access to said data file in response to said determination.
